(19) United States
(12) Patent Application Publication
(10) Pub. No.: US 2024/0203057 A1
(43) Pub. Date: Jun. 20, 2024

(54) BLENDING REGIONAL MESH MORPHS

(71) Applicant: Sky Castle Studios, LLC, San Francisco, CA (US)

(72) Inventor: Adam Garman, Waterbeach (GB)

(73) Assignee: Sky Castle Studios, LLC, San Francisco, CA (US)

(21) Appl. No.: 18/539,129

(22) Filed: Dec. 13, 2023

Related U.S. Application Data
(60) Provisional application No. 63/433,324, filed on Dec. 16, 2022.

(51) Int. Cl. G06T 17/20

(52) U.S. Cl. CPC G06T 17/205; G06T 2210/36; G06T 2210/44

(57) ABSTRACT

Aspects of the disclosure are directed to computer graphics morphing. In accordance with one aspect, a method including: generating a plurality of blended meshes; and accumulating the plurality of blended meshes to generate a final blended mesh. In accordance with one aspect, an apparatus including: means for generating a plurality of blended meshes; and means for accumulating the plurality of blended meshes to generate a final blended mesh.

### CLAIM OF PRIORITY UNDER 35 U.S.C. § 119

The present application for patent claims priority to Provisional Application No. 63/433,324 entitled “BLENDING REGIONAL MESH MORPHS” filed Dec. 16, 2022, and assigned to the assignee hereof and hereby expressly incorporated by reference herein.

### TECHNICAL FIELD

This disclosure relates generally to the field of computer graphics, and, in particular, to computer graphics morphing techniques.

### BACKGROUND

Morphing is a computer graphics processing technique which transforms an initial shape to a transformed shape through incremental transition states. Morphing is a basic operation in many computer graphics applications. To generate visually appealing morphing results, other morphing techniques are desirable for end user satisfaction.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides computer graphics morphing techniques. Accordingly, a method including: generating a plurality of blended meshes; and accumulating the plurality of blended meshes to generate a final blended mesh. In one example, the method further includes blending a plurality of smoothed version base meshes and a plurality of smoothed version morph meshes using a plurality of blend regional masks to generate the plurality of blended meshes. In one example, the method further includes generating the plurality of smoothed version base meshes from a base mesh. In one example, the method further includes determining the plurality of smoothed version morph meshes from a plurality of morph meshes. In one example, the method further includes generating the plurality of smoothed version morph meshes.

In one example, the method further includes generating a plurality of differences, wherein each of the plurality of differences is generated by calculating a difference between two consecutive smoothed versions of the plurality of smoothed version morph meshes. In one example, the method further includes creating a plurality of smoothed versions of one or more blend regions from one or more blend regions.

In one example, the method further includes: using a last of the plurality of smoothed versions of the one or more blend regions to generate a most smoothed blend regional mask; and using a next to last of the plurality of smoothed versions of the one or more blend regions to generate a second most smoothed blend regional mask. In one example, the method further includes creating the base mesh, the plurality of morph meshes, and the one or more blend regions on the base mesh. In one example, the method further includes generating a graphical product by converting the final blended mesh to one or more of the following: a skeletal pose, a pose space deformation and a normal map.

Another aspect of the disclosure provides an apparatus including: means for generating a plurality of blended meshes; and means for accumulating the plurality of blended meshes to generate a final blended mesh. In one example, the apparatus further includes means for blending a plurality of smoothed version base meshes and a plurality of smoothed version morph meshes using a plurality of blend regional masks to generate the plurality of blended meshes. In one example, the apparatus further includes means for generating the plurality of smoothed version base meshes from a base mesh. In one example, the apparatus further includes means for determining the plurality of smoothed version morph meshes from a plurality of morph meshes. In one example, the apparatus further includes means for generating the plurality of smoothed version morph meshes.

In one example, the apparatus further includes means for generating a plurality of differences, wherein each of the plurality of differences is generated by calculating a difference between two consecutive smoothed versions of the plurality of smoothed version morph meshes. In one example, the apparatus further includes means for creating a plurality of smoothed versions of one or more blend regions from one or more blend regions.

In one example, the apparatus further includes: means for using a last of the plurality of smoothed versions of the one or more blend regions to generate a most smoothed blend regional mask; and means for using a next to last of the plurality of smoothed versions of the one or more blend regions to generate a second most smoothed blend regional mask. In one example, the apparatus further includes means for creating the base mesh, the plurality of morph meshes, and the one or more blend regions on the base mesh. In one example, the apparatus further includes means for generating a graphical product by converting the final blended mesh to one or more of the following: a skeletal pose, a pose space deformation and a normal map.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example flow diagram for smoothly blending regional mesh morphs.

FIG. 2 illustrates an example linear morphing sequence with a plurality of interpolation (t) values.

FIG. 3 illustrates an example morphing sequence using blend regions.

FIG. 4 illustrates an example morphing sequence with blending of two meshes of dissimilar sizes.

FIG. 5 illustrates an example morphing sequence with spectral decomposition with a first mesh, a second mesh and a masked morph result.

FIG. 6 illustrates an example of intermediate results of the smoothing technique.

FIG. 7 illustrates an example of different combinations of spectral components.

FIG. 8 illustrates an example of an extension to the smoothing technique.

FIG. 9 illustrates an apparatus for blending regional mesh morphs.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Computer graphics involves generation and manipulation of a plurality of three-dimensional (3D) shapes for a variety of applications. In one example, image processing techniques may be used to synthesize and modify the plurality of 3D shapes to achieve a desired result. For example, one desired result may be a smooth transformation of one 3D shape into another 3D shape. In one example, morphing transforms an initial three-dimensional (3D) shape into a transformed 3D shape via an image processing technique. For example, a mesh, indexed by spatial coordinates, may serve as a basis for representing an arbitrary 3D shape. That is, the mesh forms the foundation for the arbitrary 3D shape. For example, the mesh may be a spatially sampled version of the arbitrary 3D shape. In one example, the spatial coordinates may be specified by rectangular Cartesian coordinates (x, y, z). In one example, the spatial coordinates may be specified by spherical coordinates (r, θ, φ). In one example, r is a radial coordinate, θ is a polar angle, and o is an azimuth angle.

In one example, the mesh may be defined by a plurality of vertices or spatial points defined in a spatial coordinate system, for example, rectangular Cartesian coordinates (x, y, z), cylindrical coordinates, spherical coordinates, etc. For example, the arbitrary 3D shape may be synthesized by interconnecting the plurality of vertices. In one example, each of the vertices of the plurality of vertices may be represented by a vector rₙ in the spatial coordinate system, where n is an integer index which denotes individual vertices. For example, the vector rₙ may be represented by (xₙ, yₙ, zₙ) which are rectangular Cartesian coordinates for a n^{th} vertex of the plurality of vertices. For example, a mesh with N vertices may be defined as a set of vectors {rₙ}, for n=1 to N.

In one example, the initial 3D shape may have a basis using an initial mesh, that is, a base mesh, and defined by a plurality of initial vertices. In one example, the transformed 3D shape may have a basis using a transformed mesh defined by a plurality of transformed vertices. For example, morphing may be defined as a mathematical mapping from the initial mesh (i.e., base mesh) to the transformed mesh. That is, morphing may transform the plurality of initial vertices to the plurality of transformed vertices using a sequence of incremental transition states. For example, the sequence of incremental transition states may be selected to provide a smooth transition from the initial 3D shape to the transformed 3D shape. In one example, an incremental transition state of the sequence of incremental transition states may include a plurality of incremental transition vertices. In one example, the plurality of incremental transition vertices may be represented by a vector c which is bounded with respect to a vector a which represents a plurality of initial vertices and a vector b which represents a plurality of transformed vertices. That is, bounded means the vector dot product of c with either a or b is greater than the vector dot product of a and b (i.e., a·c>a·b and b·c>a·b).

In one example, the base mesh may include a plurality of blend regions. For example, a blend region is a subset of the base mesh. That is, a plurality of vertices for any blend region is a subset of the plurality of vertices for the base mesh. In one example, the blend region corresponds to a regional spatial volume which is a subset of a base mesh spatial volume. In one example, the blend region may be used as a subset of the base mesh where at least two portions of the base mesh may be blended or smoothly interconnected.

In one example, morphing may be defined as a mathematical mapping from a plurality of initial blend regions to a plurality of transformed blend regions. That is, morphing may transform a plurality of initial vertices for each initial blend region to a plurality of transformed vertices for each transformed blend region.

In one example, morphing from a first 3D shape to a second 3D shape generates a morph. That is, the morph is a 3D shape generated by a transformation from an initial 3D shape. For example, the morph is the transformed 3D shape.

In one example, morphing is a computer graphics technique to interpolate smoothly between two meshes. For example, morphing may start with a first mesh with a plurality of first vertices and then transforms the plurality of first vertices to a plurality of second vertices. For example, the transformation from the plurality of first vertices to the plurality of second vertices is the only change introduced in the morphing.

For example, in a mathematical representation, a mesh M(x,y,z), indexed by spatial coordinates (x,y,z), may be a basis for an arbitrary 3D shape. In one example, the mesh M(x,y,z) may be represented by a weighted superposition of mesh spectral components S(u,v,w), where (u,v,w) are 3D spatial frequency coordinates, as illustrated in equation (1):

$$M ( x , y , z ) = \sum \sum \sum S ( u , v , w ) exp [ + i 2 π ( ux / {N}_{1} + vy / {N}_{2} + wz / {N}_{3} ) ] \qquad ( 1 )$$

That is, the mesh M(x,y,z) may be expressed as a spectral decomposition (i.e., Fourier transformation) where each mesh spectral component S(u,v,w) represents a constituent at 3D spatial frequency (u,v,w). In one example, the mesh M(x,y,z) may be regarded as a weighted ensemble of constituents S(u,v,w). In one example, the mesh M(x,y,z) may be represented by an approximation of the mesh spectral components S(u,v,w) using computationally simpler operations.

In one example, if the mesh M(x,y,z) has spherical symmetry, that is, M(x,y,z)=M(r), where r=√(x²+y²+z²) is a radial spatial coordinate, then its corresponding mesh spectral components may be represented by S(u,v,w)=S(ρ), where p=√(u²+v²+w²) is a radial spatial frequency. That is, with spherical symmetry, both the mesh M(r) and the mesh spectral components S(ρ) simplify to one-dimensional functions.

In one example, each mesh spectral component may be classified into distinct spectral regions, for example, as being a low frequency spectral component, a medium frequency spectral component or a high frequency spectral component. For example, the spectral region classification may be performed by comparing the radial spatial frequency ρ, defined by:

$$ρ = √ ( {u}^{2} + {v}^{2} + {w}^{2} ) , \qquad ( 2 )$$

$$with S ( ρ ) = S ( u , v , w ) \qquad ( 3 )$$

to a low frequency boundary ρ_{low} and a high frequency boundary ρ_{high} such that 0≤

$${ρ}_{low} \leq {ρ}_{high} \leq {ρ}_{max} \\ where {ρ}_{max} = max \{ √ ( {u}^{2} + {v}^{2} + {w}^{2} ) \} . \qquad ( 4 )$$

In one example, the radial spatial frequency ρ may be radial along a surface. In one example, radial spatial frequencies p which satisfy ρ≤ρ_{low} define a low spatial frequency region where the mesh M(x,y,z) or M(r) has slow spatial variation over the spatial coordinates. In one example, radial spatial frequencies ρ which satisfy ρ>ρ_{high} define a high spatial frequency region where the mesh M(x,y,z) or M(r), has rapid spatial variation over the spatial coordinates. In one example, radial spatial frequencies ρ which satisfy ρ_{low}<ρ≤ρ_{high} define a medium spatial frequency region where the mesh M(x,y,z) or M(r), has moderate spatial variation over the spatial coordinates.

In one example, a transfer function T(ρ) may be defined as a function of radial spatial frequency ρ to specify a filtering operation. In one example, a mesh M(r) with mesh spectral components S(ρ), may be filtered by a filtering operation with transfer function T(ρ) to form filtered mesh spectral components N(ρ)=S(ρ)T(ρ). In one example, a filtered mesh N(r) which results from the filtering operation on the mesh M(r) may be determined by an inverse transformation from the filtered mesh spectral components N(ρ). Alternatively, in one example, the filtered mesh N(r) may be determined by a convolution operation between the mesh M(r) and a point spread function T(r). In one example, the point spread function T(r) is defined as an inverse transform of the transfer function T(ρ).

In one example, if the filtering operation implements a smoothing operation on a function, then the transfer function T(ρ) is a low pass spatial filter L(ρ). For example, an ideal low pass spatial filter Lᵢ(ρ) has a filtering property such that |Lᵢ(ρ)|=1 for ρ≤ρ_{bw} and |Lᵢ(ρ)|=0 for ρ>ρ_{bw}, where ρ_{bw} is a spatial filter bandwidth. That is, the ideal low spatial filter allows only low spatial frequencies in the filtered mesh N(r). In one example, the ideal low pass spatial filter smooths the mesh M(r) to form the filtered mesh N(r). In one example, the low pass spatial filter L(ρ) approximates the ideal low pass spatial filter Lᵢ(ρ) with a realizable filter function.

Then, the spectral region classification may be determined by the following three spectral regions test:
if p≤ρ_{low} S(ρ) is a low frequency spectral component,
if ρ_{low}<p≤ρ_{high} S(ρ) is a medium frequency spectral component,
if p>ρ_{high} S(ρ) is a high frequency spectral component.

For example, if only two spectral regions, low frequency and high frequency, are classified, then the above formulation may still be used if ρ_{low}=ρ_{high} and the spectral region classification may be determined by the following two spectral regions test:
if ρ≤ρ_{low} S(ρ) is a low frequency spectral component,
if ρ≥ρ_{low} S(ρ) is a high frequency spectral component.

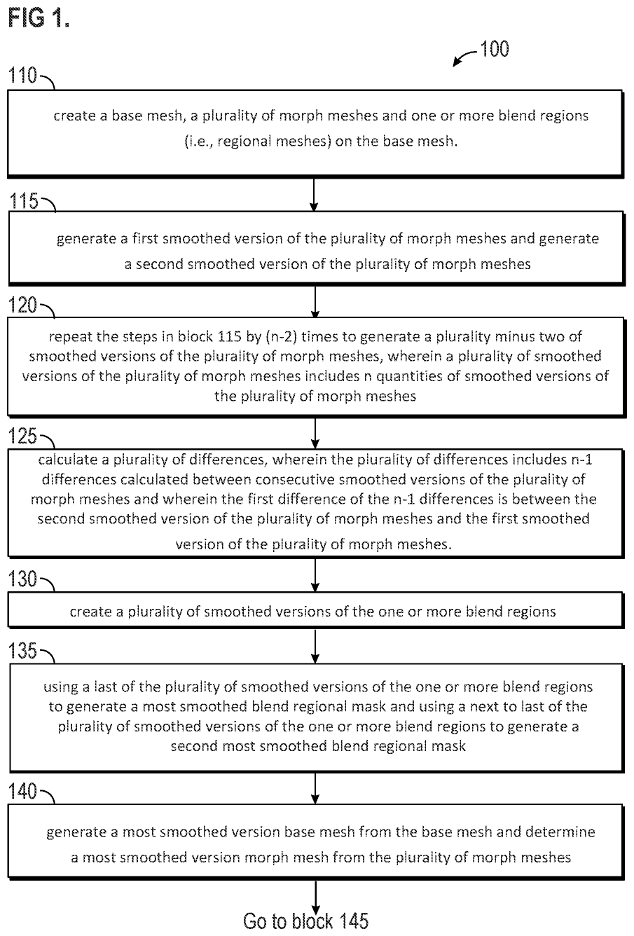

FIG. 1 illustrates an example flow diagram 100 for smoothly blending regional mesh morphs. In block 110, create a base mesh, a plurality of morph meshes and one or more blend regions (i.e., regional meshes) on the base mesh. In one example, creating means authoring. In one example, the base mesh is a spatially sampled version of a reference 3D shape. In one example, the reference 3D shape is an initial 3D shape. In one example, the base mesh is indexed using spatial coordinates. In one example, the spatial coordinates are rectangular Cartesian coordinates (x, y, z). In one example, the spatial coordinates are spherical coordinates (r, θ, φ). In one example, each morph mesh of the plurality of morph meshes includes a plurality of incremental transition vertices. In one example, the blend regions are subsets of the base mesh. In one example, a plurality of base meshes may be created.

In block 115, generate a first smoothed version of the plurality of morph meshes and generate a second smoothed version of the plurality of morph meshes. In one example, a smoothed version of the morph mesh may be created by using a last smooth version of a plurality of increasingly smoothed versions of each morph mesh of the plurality of morph meshes.

In block 120, repeat the steps in block 115 by (n−2) times to generate a plurality minus two of smoothed versions of the plurality of morph meshes, wherein a plurality of smoothed versions of the plurality of morph meshes includes n quantities of smoothed versions of the plurality of morph meshes. In one example, n is an integer based on user choice, computational constraints or application requirements.

In one example, a mesh M(r) as a function of radial coordinate r is radially symmetric with a spectral component S(ρ) as a function of radial spatial frequency ρ which is also radially symmetric. In one example, the sequence of smoothed versions of a radially symmetric mesh M(r) may be created by successively applying (e.g., multiplying) a sequence of low pass spatial filters Lₖ(ρ) (i.e., L₁(ρ), L₂(ρ), L₃(ρ), etc.) to the mesh spectral components S(ρ). In one example, the sequence of low pass spatial filters Lₖ(ρ) are indexed by k=1, 2, 3, . . . and successively have narrower spectral bandwidths Bₖ. That is, B₁>B₂>B₃>B₄, etc. In one example, spectral bandwidth is a measure of spectral component width in the spatial frequency domain. In one example, a narrower spectral bandwidth corresponds to an increase in smoothing of the mesh M(r). That is, the narrower spectral bandwidth results in a smoother version of the mesh M(r).

In block 125, calculate a plurality of differences, wherein the plurality of differences includes n−1 differences calculated between consecutive smoothed versions of the plurality of morph meshes and wherein the first difference of the n−1 differences is between the second smoothed version of the plurality of morph meshes and the first smoothed version of the plurality of morph meshes.

In one example, the n−1 differences are calculated in object space. In another example, the n−1 differences are calculated in tangent space. For example, determine a plurality of difference versions between each smoothed version and each next less smoothed version of each mesh of the plurality of morph meshes. In one example, a smoothed version of a mesh is denoted as Nⱼ(r) and is obtained by filtering the mesh M(r) using a jth member Lⱼ(ρ) of the sequence of low pass spatial filters. In one example, the next less smoothed version of the mesh is denoted as Nⱼ₋₁(r) and is obtained by filtering the mesh M(r) using a (j−1)th member Lⱼ₋₁(ρ) of the sequence of low pass spatial filters. In one example, a jth difference Dⱼ(r)=Nⱼ(r)−Nⱼ₋₁(r). In one example, the difference may be calculated in object space, where the object space is defined with respect to spatial coordinates of the mesh M. In one example, the difference may be calculated in tangent space, where the tangent space is defined with respect to spatial coordinates of tangent surfaces of the mesh.

In block 130, create a plurality of smoothed versions of the one or more blend regions from one or more blend regions. For example, generate a plurality of smoothed versions of the one or more blend regions. In one example, a blend region P(r) as a function of radial coordinate r is radially symmetric with a regional spectral component Q(ρ) as a function of radial spatial frequency ρ which is also radially symmetric. In one example, the sequence of smoothed versions of blend region P(r) may be created by successively applying (e.g., multiplying) the sequence of low pass spatial filters Lₖ(ρ) (i.e., L₁(ρ), L₂(ρ), L₃(ρ), etc.) to the regional spectral component Q(ρ). In one example, the sequence of low pass spatial filters Lₖ(ρ) are indexed by k=1, 2, 3, . . . and successively have narrower spectral bandwidths Bₖ.

In block 135, using a last of the plurality of smoothed versions of the one or more blend regions to generate a most smoothed blend regional mask and using a next to last of the plurality of smoothed versions of the one or more blend regions to generate a second most smoothed blend regional mask. In one example, the second most smoothed blend regional mask has a smoothness property which is closest to the smoothness property of the most smoothed blend regional mask. In one example, the smoothness property relates to spectral bandwidths Bₖ indexed by k=1, 2, 3, . . . . In one example, a first mask closest to the smoothness property of a second mask means the spectral bandwidth of the first mask is closest to the spectral bandwidth of the second mask.

In block 140, generate a most smoothed version base mesh from the base mesh and determine a most smoothed version morph mesh from the plurality of morph meshes.

In block 145, generate a second most smoothed version base mesh from the base mesh and determine a second most smoothed version morph mesh from the plurality of morph meshes.

In block 150, repeat the step in block 145 (n−2) times to generate a plurality minus two of a next most smoothed version base mesh from the base mesh and a plurality minus two of a next most smoothed version morph mesh from the plurality of morph meshes. In one example, the plurality minus two of the next most smoothed version base mesh includes all smoothed versions of the base mesh excluding the most smoothed version base mesh and the second most smoothed version base mesh. In one example, the plurality minus two of the next most smoothed version morph mesh includes all smoothed versions of the morph mesh excluding the most smoothed version morph mesh and the second most smoothed version morph mesh.

In block 155, blend the most smoothed version base mesh and the most smoothed version morph mesh using the most smoothed blend regional mask to generate a first blended mesh. In one example, the blending may be performed in either the object space or the tangent space.

In block 160, blend the second most smoothed version base mesh and the second most smoothed version morph mesh using the second most smoothed blend regional mask to generate a second blended mesh. In one example, the blending may be performed in either the object space or the tangent space.

In block 165, repeat the step in block 160 (n−2) times to generate a plurality minus two of blended meshes.

In block 170, accumulate the first blended mesh, the second blended mesh and the plurality minus two of blended meshes to generate a final blended mesh. In one example, the accumulation is performed in object space. In one example, the accumulation is performed in tangent space.

In block 175, generate a graphical product by converting the final blended mesh to one or more of the following: a skeletal pose, a pose space deformation and a normal map.

In one example, the graphical product is generated by a graphics processor and presented on a graphical display unit. In one example, one or more of the processing steps described in FIG. 1 is performed by one or more processing engines, such as a central processor and/or an image processor. In one example, one or more of the processing steps described in FIG. 1 is performed by one or more low-end (e.g., inexpensive) hardware.

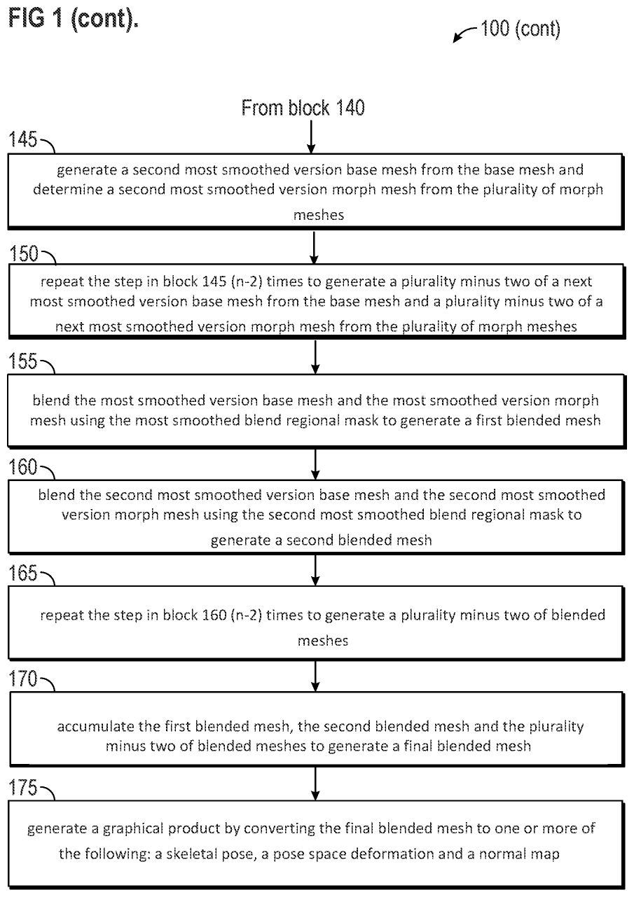

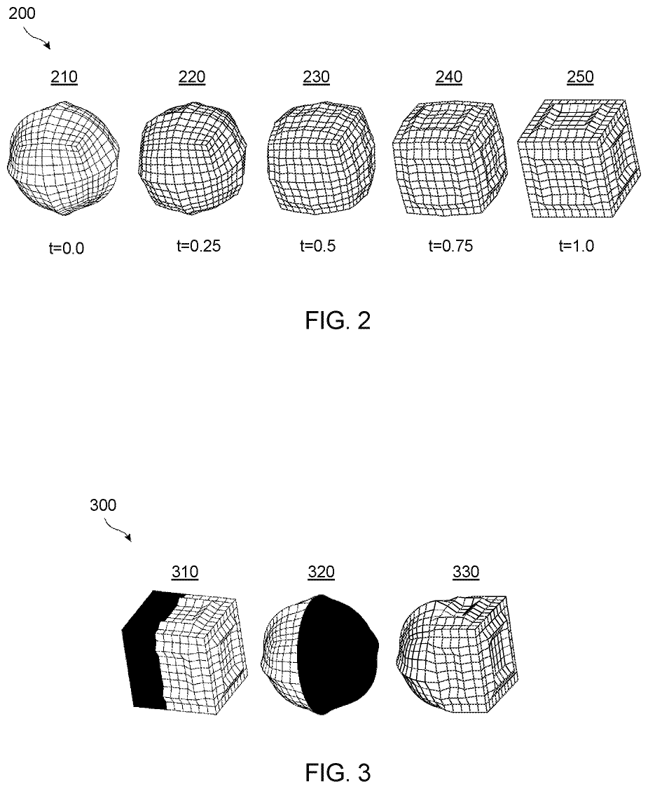

FIG. 2 illustrates an example linear morphing sequence 200 with a plurality of interpolation (t) values. For example, an initial 3D shape 210 on the left side of FIG. 2 is linearly morphed to a transformed 3D shape 250 on the right side of FIG. 2. For example, a sequence of incremental transition states, shown as the middle three 3D shapes 220, 230, 240 in FIG. 2, illustrate a linear interpolation between the initial 3D shape 210 and the transformed 3D shape 250.

FIG. 3 illustrates an example morphing sequence 300 using blend regions. For example, a plurality of regions of an initial 3D shape is morphed into a plurality of regions of a transformed 3D shape. In one example, a regional morphing sequence may employ a plurality of numerical weights for each initial vertex position and may multiply an interpolated value by a numerical weight when calculating a transformed vertex position. For example, FIG. 3 shows a base 3D shape with base mask weights 310, a morph target 3D shape with target mask weights 320 and a masked morph combination 3D shape 330.

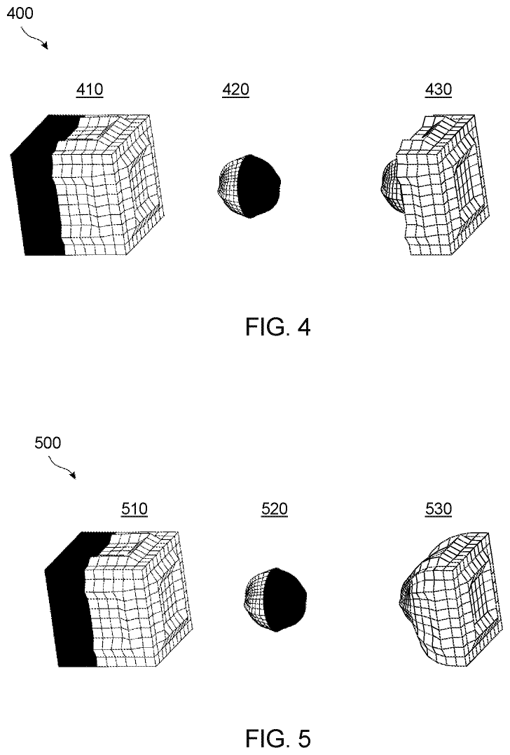

FIG. 4 illustrates an example morphing sequence 400 with blending of two meshes of dissimilar sizes, a first mesh 410 and a second mesh 420. For example, usage of blend regions may produce desirable results in many cases. However, for example, usage of blend regions may produce undesirable results in some cases when two shapes of dissimilar sizes are morphed. That is, discontinuous interfaces between blend regions may be obvious. For example, in FIG. 4, there is an obvious discontinuity in the masked morph result 430 shown on the right side of the figure.

FIG. 5 illustrates an example morphing sequence 500 with spectral decomposition with a first mesh 510, a second mesh 520 and a masked morph result 530. For example, one approach to avoiding a discontinuity in the masked morph result is to smooth regional blend factors. However, this smoothing technique may extend morph details into unwanted spatial locations. In one example, a smoothing technique may use a plurality of morph meshes where each morph mesh contains a specific spectral component of the original morph. Subsequently, regional blend factors may be smoothed by a matching amount for each morph mesh spectral component and then blending the smoothed morph mesh spectral components together. In one example, this smoothing technique may smooth undesirable discontinuities between blended regions without placing higher spatial frequency spectral components into undesired areas.

In one example, the smoothing technique may be implemented by first generating multiple increasingly smoothed versions of the base mesh and target mesh. Next, the multiple increasingly smooth versions may be used to generate morph meshes by calculating differences between each sequential pair of smoothed versions of the mesh. For example, each difference approximates one spectral component of the original mesh. Next, the vertex blend weight masks may be smoothed so that they have similar characteristics to positional changes. Next, each difference may be blended by their corresponding smoothed regional mask, and all blended differences may be accumulated to yield the plurality of transformed blend regions.

In one example, an arbitrary mesh smoothing operator may be used for generating frequency morphs, with differing results dependent on mesh characteristics. For example, the smoothing technique moves each vertex to a Gaussian weighted mean position of points on a disk surface around each vertex.

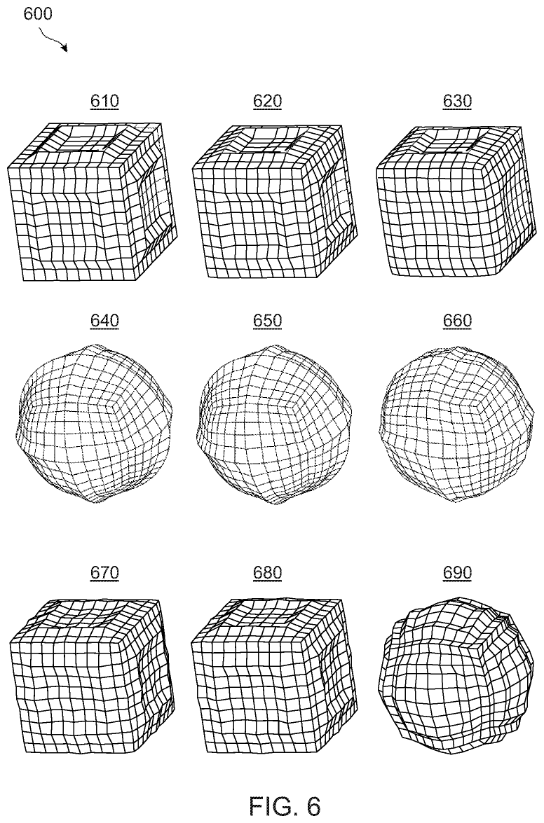

FIG. 6 illustrates an example of intermediate results 600 of the smoothing technique. For example, the first two rows of FIG. 6 show example meshes 610 and 640 and two levels of smoothing 620, 630 and 650, 660 which remove increasing amount of detail. For example, the third row of FIG. 6 shows results 670, 680, 690 of replacing one level of detail from the first row with the corresponding level of detail from the second row.

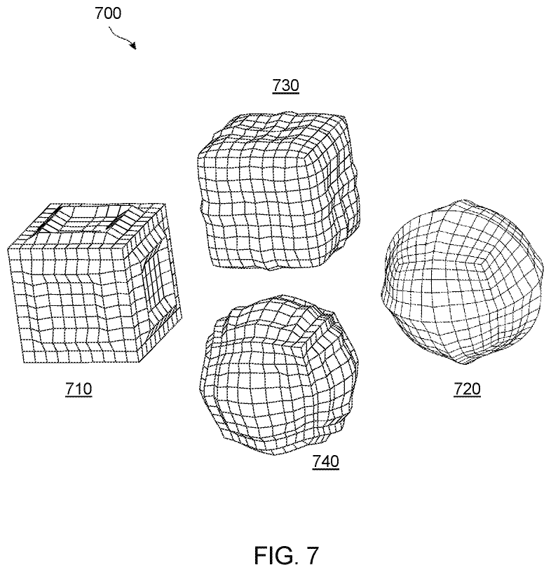

FIG. 7 illustrates an example of different combinations 700 of spectral components. For example, different combinations of spectral components from the left mesh 710 and the right mesh 720 of FIG. 7 may be applied. For example, the upper mesh 730 of FIG. 7 combines low spatial frequency spectral components from the left mesh 710 with high spatial frequency spectral components from the right mesh 720. For example, the lower mesh 740 of FIG. 7 combines high spatial frequency spectral components from the left mesh 710 with low spatial frequency spectral components from the right mesh 720.

In another example, an extension to the improved smoothing technique may be to apply a subset of spectral components in tangent space. For example, high spatial frequency spectral components from a first mesh may be combined with low spatial frequency spectral components of the tangent space of a second mesh. For example, the low spatial frequency spectral components may be applied as a simple object space linear blend with subsequent morphs tangent space differences applied sequentially in the tangent space of the previously morphed result. In one example, this technique may be more computationally intensive but may provide improved results in certain scenarios.

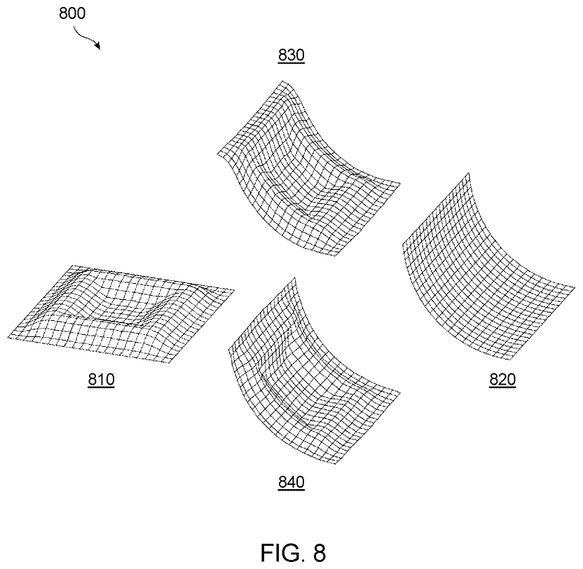

FIG. 8 illustrates an example of an extension 800 to the smoothing technique. For example, the middle two meshes 830, 840 of FIG. 8 both include high spatial frequency spectral components from the left mesh 810 and low spatial frequency spectral components from the right mesh 820. For example, the upper mesh 830 uses simple linear blending and experiences some distortion in its top edge due to an orientation change. For example, the lower mesh 840 applies high spatial frequency spectral components in the tangent space of the low spatial frequency spectral components and does not experience distortion in its top edge.

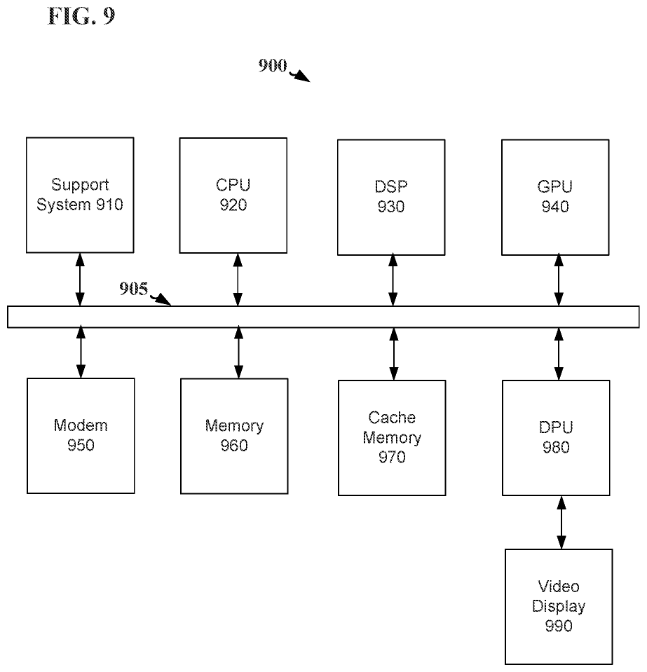

FIG. 9 illustrates an example apparatus 900 for blending regional mesh morphs. In one example, the information processing system 900 includes a plurality of processing engines such as a central processing unit (CPU) 920, a digital signal processor (DSP) 930, a graphics processing unit (GPU) 940, a display processing unit (DPU) 980, etc. In one example, various other functions in the information processing system 900 may be included such as a support system 910, a modem 950, a memory 960, a cache memory 970 and a video display 990. For example, the plurality of processing engines and various other functions may be interconnected by an interconnection databus 905 to transport data and control information.

For example, the memory 960 and/or the cache memory 970 may be shared among the CPU 920, the GPU 940 and the other processing engines. In one example, the CPU 920 may include a first internal memory which is not shared with the other processing engines. In one example, the GPU 940 may include a second internal memory which is not shared with the other processing engines. In one example, any processing engine of the plurality of processing engines may have an internal memory (i.e., a dedicated memory) which is not shared with the other processing engines. Although several components of the information processing system 900 are included herein, one skilled in the art would understand that the components listed herein are examples and are not exclusive. Thus, other components may be included as part of the information processing system 900 within the spirit and scope of the present disclosure.

In one example, one or more processing engines in the information processing system 900 may be aggregated into a single integrated circuit known as a system on a chip (SOC). In one example, the SOC may include the central processing unit (CPU) 920 and other processing engines such as the DSP 930 or the GPU 940. The SOC may also include the memory 960 and the cache memory 970.

In one example, the information processing system 900 may be part of a wireless device in a wireless communication system. For example, the wireless communication system may conform to a wireless network protocol such as 4G LTE (long term evolution), 5G NR (new radio), etc.

In one example, the memory 960 and the cache memory 970 of the information processing system 900 may be implemented by a variety of memory technologies. In one example, a first memory technology is dynamic random access memory (DRAM) which is a fast, high density volatile memory. In one example a second memory technology is a static random access memory (SRAM) which is a faster speed, lower density volatile memory. In one example, a DRAM may be utilized for bulk storage requirements and a SRAM may be utilized for local storage requirements.

In one example, sequential tangent space blending may be executed in modern graphical APIs (Application Programing Interfaces) with support compute shaders. In one example, for graphical APIs which support only vertex and fragment shaders, such as WebGL, three levels of spectral blending may be executed by transforming the data for use in standard rendering techniques. For example, the lowest spatial frequency morph may be applied using skeletal deformation in the vertex shader. For example, middle spatial frequency blends may be applied using linear morphs in the vertex shader transformed into pose space of a pre-calculated skeleton. For example, the high spatial frequency morph may be applied using a normal map blending in the fragment shader.

In one example, each of the steps in blocks 110, 115, 120, 125, 130, 135, 140, 145, 150, 155,160, 165, 170 of FIG. 1 may be executed by one of more of the following: CPU 920, DSP 930. GPU 940 or DPU 980 working in conjunction with one or more of the following memory 960 or cache memory 970. In one example, the step of block 175 may be executed by the DPU 980 working in conjunction with the video display 990.

In one aspect, one or more of the steps for providing computer graphics morphing techniques in FIG. 1 may be executed by one or more processors which may include hardware, software, firmware, etc. The one or more processors, for example, may be used to execute software or firmware needed to perform the steps in the flow diagram of FIG. 1. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method comprising:
generating a plurality of blended meshes; and
accumulating the plurality of blended meshes to generate a final blended mesh.

2. The method of claim 1, further comprising blending a plurality of smoothed version base meshes and a plurality of smoothed version morph meshes using a plurality of blend regional masks to generate the plurality of blended meshes.

3. The method of claim 2, further comprising generating the plurality of smoothed version base meshes from a base mesh.

4. The method of claim 3, further comprising determining the plurality of smoothed version morph meshes from a plurality of morph meshes.

5. The method of claim 4, further comprising generating the plurality of smoothed version morph meshes.

6. The method of claim 5, further comprising generating a plurality of differences, wherein each of the plurality of differences is generated by calculating a difference between two consecutive smoothed versions of the plurality of smoothed version morph meshes.

7. The method of claim 6, further comprising creating a plurality of smoothed versions of one or more blend regions from one or more blend regions.

8. The method of claim 7, further comprising:
using a last of the plurality of smoothed versions of the one or more blend regions to generate a most smoothed blend regional mask; and
using a next to last of the plurality of smoothed versions of the one or more blend regions to generate a second most smoothed blend regional mask.

9. The method of claim 8, further comprising creating the base mesh, the plurality of morph meshes, and the one or more blend regions on the base mesh.

10. The method of claim 9, further comprising generating a graphical product by converting the final blended mesh to one or more of the following: a skeletal pose, a pose space deformation and a normal map.

11. An apparatus comprising:
means for generating a plurality of blended meshes; and
means for accumulating the plurality of blended meshes to generate a final blended mesh.

12. The apparatus of claim 11, further comprising means for blending a plurality of smoothed version base meshes and a plurality of smoothed version morph meshes using a plurality of blend regional masks to generate the plurality of blended meshes.

13. The apparatus of claim 12, further comprising means for generating the plurality of smoothed version base meshes from a base mesh.

14. The apparatus of claim 13, further comprising means for determining the plurality of smoothed version morph meshes from a plurality of morph meshes.

15. The apparatus of claim 14, further comprising means for generating the plurality of smoothed version morph meshes.

16. The apparatus of claim 15, further comprising means for generating a plurality of differences, wherein each of the plurality of differences is generated by calculating a difference between two consecutive smoothed versions of the plurality of smoothed version morph meshes.

17. The apparatus of claim 16, further comprising means for creating a plurality of smoothed versions of one or more blend regions from one or more blend regions.

18. The apparatus of claim 17, further comprising:
means for using a last of the plurality of smoothed versions of the one or more blend regions to generate a most smoothed blend regional mask; and
means for using a next to last of the plurality of smoothed versions of the one or more blend regions to generate a second most smoothed blend regional mask.

19. The apparatus of claim 18, further comprising means for creating the base mesh, the plurality of morph meshes, and the one or more blend regions on the base mesh.

20. The apparatus of claim 19, further comprising means for generating a graphical product by converting the final blended mesh to one or more of the following: a skeletal pose, a pose space deformation and a normal map.
